(19) United States
(12) Patent Application Publication
(10) Pub. No.: US 2022/0213251 A1
(43) Pub. Date: Jul. 7, 2022

(54) METHOD FOR SURFACE FUNCTIONALIZATION IN A SUPERCRITICAL FLUID MEDIUM

(71) Applicant: COMMISSARIAT A L'ENERGIE ATOMIQUE ET AUX ENERGIES ALTERNATIVES, Paris (FR)

(72) Inventors: Olivier PONCELET, Grenoble Cedex 09 (FR); Olivier BLANCHOT, Grenoble Cedex 09 (FR); Jerome DELMAS, Grenoble Cedex 09 (FR); Olivier RENARD, Grenoble Cedex 09 (FR); Isabelle ROUGEAUX, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/604,160

(22) PCT Filed: Apr. 14, 2020
(86) PCT No.: PCT/EP2020/060427

§ 371 Date: Oct. 15, 2021

(30) Foreign Application Priority Data
Apr. 16, 2019 (FR) 19 04061

(51) Int. Cl. C08G 18/38; C08J 7/16; D06M 13/395; C03C 25/25

(52) U.S. Cl. CPC C08G 18/3844; C08G 18/3819; C08J 7/16; D06M 13/395; C03C 25/25; D06M 2101/06; C08J 2301/02; C08J 2397/02; C08J 2377/02; C08J 2377/06; C08J 2475/04

(57) ABSTRACT

A method for functionalizing the surface of a substrate, performed in a supercritical fluid medium, may include: (i) providing a substrate having labile hydrogen functions on the surface; (ii) bringing the substrate into contact, in a supercritical fluid, with at least one organic molecule carrying at least one blocked isocyanate function which can be activated by heating; and (iii) subjecting the whole to a temperature sufficient to bring about the release of the blocked isocyanate function carried by the molecule, and the covalent grafting of the molecule by reaction of the isocyanate function with a labile hydrogen function on the surface of the substrate.

### TECHNICAL FIELD

The present invention pertains to a new technique for surface functionalization of a substrate having labile hydrogen functions, which is useful, for example, for surface functionalization of polymeric organic matrices, and which is performed in a supercritical fluid medium, more particularly in a supercritical carbon dioxide medium.

### PRIOR ART

For numerous applications, especially in bioengineering and in the medical field, controlling the surface nature of the materials employed, such as organic polymeric matrices, is one means of adjusting and optimizing their properties. Accordingly, numerous technologies have been proposed for carrying out surface modification of substrates, for example of polymeric organic matrices, for the purpose of modifying their physical properties, such as their color, their scratch resistance, their impact resistance or their wettability properties.

Particularly favored among these technologies are those which enable covalent grafting of a group or a molecule of interest on the surface of the substrate, in order to obtain durable functionalization of the substrate over time. Likewise, in the context of preparing materials for applications such as bioengineering and medical engineering, favored techniques are those which minimize the amount of residues in the resulting material, or those which do not involve the use or the formation of associated byproducts, such as surfactants, which are difficult to remove.

In this context, fluids known as supercritical fluids, such as supercritical carbon dioxide (also denoted “supercritical CO₂” or “sCO₂”), have already been proposed as vectors for impregnating substrates. Supercritical CO₂ is particularly advantageous in terms of its cost, its ease of use, its lack of flammability, its nontoxicity, and its good solvent properties.

### SUMMARY OF THE INVENTION

A specific object of the present invention is to provide a new path for surface-modifying a substrate, for example a substrate of polymeric organic matrix type, performed in a supercritical fluid medium, that meets the various aforesaid expectations.

More specifically, the present invention provides a new technique for durably functionalizing the surface of a substrate, which is performed in a supercritical fluid medium, which allows the surface of the substrate to be grafted covalently with one or more groups of interest, denoted R_{f}, more particularly via the establishment of urethane-type covalent bonds, while being independent of the use of isocyanate compounds.

The invention accordingly concerns a method for functionalizing the surface of a substrate, performed in a supercritical fluid medium, implementing at least the steps consisting of:

(i) providing a substrate having labile hydrogen functions on the surface;

(ii) bringing said substrate into contact, in a supercritical fluid, more particularly in supercritical CO₂, with at least one organic molecule carrying at least one blocked isocyanate function which can be activated by heating; and

(iii) subjecting the whole to a temperature sufficient to bring about the release of said blocked isocyanate function carried by the molecule, and the covalent grafting of said molecule by reaction of said isocyanate function with a labile hydrogen function on the surface of the substrate.

The substrate in question according to the invention is preferably an organic polymeric matrix having labile hydrogen functions on the surface, such as, more particularly, hydroxyl functions.

A “supercritical fluid” in the sense of the invention refers to a fluid in a supercritical state, especially supercritical CO₂.

Advantageously, all of the steps of the method of the invention may be performed within a single reactor (autoclave), suitable for working in a fluid in a supercritical state, for example supercritical CO₂. Accordingly, in the remainder of the text, the term “reactor” will be used to denote the reactor or autoclave in which the steps of the method according to the invention are performed. The reactor in question is more particularly a reactor operating in batch mode (“batch reactor”).

A “blocked isocyanate function” refers to an isocyanate function which is inactivated by the presence of a blocking agent, as described more specifically in the remainder of the text. A blocked isocyanate function may be capable of being released, in other words deblocked or activated, under the effect of heat.

More particularly, as detailed in the remainder of the text, a blocked isocyanate function may be suitable for being released in order to generate an isocyanate function, by heating beyond a given temperature, called the activation temperature.

A blocked isocyanate function may especially be a urethane-type function or a urea-type function. In the sense of the invention, a function, of urethane or urea type for example, is said to be “reversible” or else “thermolabile” when it is suitable for generating an isocyanate function by heating.

Advantageously, the method of the invention removes the need to use solvents, more particularly organic solvents which are flammable and/or toxic.

In fact, in contrast to organic solvents, supercritical fluids, such as supercritical CO₂, do not require a step of recycling or treatment after they have been used. Carbon dioxide, for example, may be liberated in gas form at the end of the treatment. In the context of an industrial reactor, CO₂ may also be recycled.

Moreover, the method of the invention advantageously removes the need for handling of isocyanate compounds, since only molecules which carry blocked isocyanate functions, which are not reactive, are charged to the reactor when the method of the invention is implemented, with the reactive isocyanate functions being generated only in situ on the substrate to be functionalized in the reactor, by heating. The method of the invention therefore meets the increasingly restrictive environmental regulatory constraints on the use of isocyanates, apart from synthesis intermediates.

What is more, the fact of transporting a molecule carrying a blocked isocyanate function by the supercritical fluid, especially by the supercritical CO₂, advantageously introduces a great flexibility for performing the grafting of the molecule on the surface of the substrate. More particularly, where the aim is to increase the solubility of the molecule for grafting in the supercritical fluid, but without increasing the pressure and/or the temperature, it is possible, in the context of the method according to the invention, to add one or more cosolvents such as methanol or ethanol. For obvious reasons, the addition of such cosolvents would not be practicable when employing compounds carrying nonblocked isocyanate functions.

Similarly, the method of the invention does not require the implementation of a prior dehydration treatment of the substrate to be functionalized, to remove the residual free water, and nor does it require operation under a controlled atmosphere (nitrogen or argon). Furthermore, the method of the invention does not require washing and/or purifying steps in order to recover the substrate thus surface-modified at the end of the covalent grafting of said molecule, as the supercritical fluid enables ready removal of all of the byproducts formed during the method of the invention, such as, for example, the blocking agents liberated during the activation of the blocked isocyanate functions, any solvent(s), or the products not consumed.

Lastly, as detailed in the remainder of the text, it is possible, employing molecules which carry a plurality of different blocked isocyanate functions, examples being molecules derived from diisocyanate or triisocyanate compounds, to optimize the degree of grafting (or degree of coverage) obtained, in other words to maximize the groups of interest which are grafted per sites available (reactive labile hydrogen functions) on the surface of the substrate.

Other features, variants and advantages of the functionalization method according to the invention will become better apparent from a reading of the description, the examples and figures which follow, which are given to illustrate and not to limit the invention.

### BRIEF DESCRIPTION OF THE DRAWINGS

FIG. 1 represents, schematically, the preparation of a compound having a thermolabile urethane function and a thermolabile urea function (blocked isocyanate functions), according to example 1.

FIG. 2 represents, schematically, the reactions for surface-functionalizing a substrate according to example 1, on the basis of a compound having a thermolabile urethane function and a thermolabile urea function;

FIG. 3 represents, schematically, the reactions for surface-functionalizing a substrate according to example 2, on the basis of a triurethane compound in which only one urethane function is thermolabile;

FIG. 4 represents, schematically, the reactions for surface-functionalizing a substrate according to example 3, on the basis of a trifunctional compound having two thermolabile urea functions and one thermolabile urethane function.

In the remainder of the text, the expressions “of between . . . and . . . ” and “ranging from . . . . . .” and “varying from . . . to . . . ” are equivalent and are intended to signify that the end points are included, unless otherwise stated.

Unless otherwise indicated, the expression “containing/comprising a(n)” should be understood as “containing/comprising at least one”.

### DETAILED DESCRIPTION

Supercritical Fluid Medium

As set out above, the method of the invention is performed in a fluid in a supercritical state. This is referred to more simply in the remainder of the text as “supercritical medium”.

This supercritical fluid is generated from a gas of at least one dry aprotic compound. In the sense of the invention, a fluid is utilized in its supercritical state when its temperature is brought beyond its critical temperature and when it is compressed above its critical pressure.

The supercritical fluid suitable for the present invention may be any appropriate fluid such as, for example, carbon dioxide, ethane, propane, butane, dimethyl ether, and mixtures thereof, to the exclusion of water.

The functionalization method according to the invention is preferably performed in supercritical CO₂.

The reactor charged with supercritical CO₂ may more particularly be maintained, during the functionalization method according to the invention, under pressure conditions of between 70 bar and 1000 bar, more particularly between 100 bar and 350 bar, and under temperature conditions of between 34° C. and 170° C., especially between 70° C. and 120° C.

The temperature and pressure conditions are more particularly adjusted with regard to the thermal stability of the substrate to be functionalized, or else with regard to the temperature at which the isocyanate function of the molecule to be grafted is released.

Substrate Having Labile Hydrogen Functions

As mentioned above, the method of the invention enables functionalization of a substrate having labile hydrogen functions on the surface.

A labile hydrogen function is capable of interacting with an isocyanate function to form a covalent bond.

The substrate employed according to the invention may be of various kinds, provided that it has, optionally at the end of a prior treatment, labile hydrogen functions which are reactive with isocyanate functions.

The labile hydrogen functions may especially be selected from hydroxyl (—OH), primary amine (—NH₂), secondary amines (—NHR) and carboxylic acid (—COOH) functions.

Preferably, as illustrated in the examples hereinafter, the substrate carries hydroxyl functions, which are capable of interacting with isocyanate functions to form covalent urethane bonds.

The substrate may be organic and/or inorganic in nature.

It may be selected from organic polymeric matrices, optionally incorporating one or more inorganic fillers, and from inorganic substrates.

It may be diverse in its form and its dimensions—for example, in the form of a flat substrate or in a particulate form, for example in the form of microparticles.

According to one particular embodiment, the substrate comprises, or is even formed of, an organic polymeric matrix.

The organic polymeric substrate may especially be selected from the group containing cellulose fibers (amorphous or crystalline cellulose), such as cotton and paper, wood, polymethylmethacrylate (PMMA), ethylene-vinyl acetate (EVA), partially or totally hydrolyzed polyvinyl acetate (PVA), preferably have a degree of hydrolysis of more than 88%, and polyamides, such as polyamide 6 (PA6), polyamide 6-6 (PA66), polyamide 11 (PA11) and polyamide 12 (PA12).

According to another variant embodiment, the substrate may be inorganic in nature.

It may be, for example, a substrate made of glass fibers, of silica, titanium, hydroxyapatite, CaCO₃, Al₂O₃, magnesium hydroxide, talc, aluminum trihydroxide, phyllosilicate clay, smectite, laponite, cloisite, hectorite, halloysite, imogolite, allophane, gibbsite, sepiolite, etc.

The substrate is preferably a silica substrate.

The reactive hydroxyl functions on the surface of the inorganic substrate (silanol units Si—OH) may be obtained by a prior surface dehydration treatment on the substrate.

This treatment may advantageously be performed in a supercritical medium, for example in a supercritical CO₂ medium. Adjusting the conditions under which the dehydration treatment is implemented in contact with the supercritical CO₂ is within the competences of the skilled person.

The temperature of the dehydration treatment may preferably be between 50° C. and 170° C., more particularly between 50° C. and 100° C. The pressure during the dehydration treatment may be between 80 bar and 400 bar, more particularly between 200 and 300 bar.

Advantageously, the surface dehydration treatment on the substrate and the steps of functionalizing the surface according to the method of the invention (steps (ii) and (iii)) which are described in the remainder of the text may be carried out successively within a single reactor, without taking the substrate from the reactor.

The substrate may also be composite in nature. Composite substrates comprise, generally speaking, a polymeric matrix in which fillers are dispersed, in the form of particles with varied size and shape.

The substrate may, for example, comprise an organic polymeric matrix with one or more inorganic fillers as described above dispersed therein.

The polymeric matrix may be diverse in nature—for example, it may be as described above, or else it may be a polyolefin matrix, made for example of polyethylene (PE) and/or polypropylene (PP), of polyethylene terephthalate) (PET) or of poly(butylene terephthalate) (PBT). The fillers may be, for example, fibers or beads of glass, silica or clays, aluminum hydroxide (Al(OH)₃), aluminum oxyhydroxide (AlO(OH)) and talc, etc.

Covalent Grafting of a Molecule Carrying Blocked Isocyanate Function(s)

The molecule carrying one or more blocked isocyanate functions that is used in step (ii) of the method of the invention may of course be of a variety of kinds, with regard especially to the application envisaged for the substrate functionalized according to the invention. More particularly, as detailed in the remainder of the text, the molecule may contain not only at least said blocked isocyanate function intended to enable, by activation, the grafting of said molecule in step (iii) by interaction between a surface labile hydrogen function and the activated isocyanate function, but also one or more groups, denoted R_{f}, having properties of interest, also called “groups of interest”.

“Group of interest” in the sense of the invention denotes a group which has particular properties and whose grafting to the surface of the substrate is desired. The group may be of various kinds, depending on the desired functionality.

According to one variant embodiment, as detailed in the remainder of the text, the molecule may therefore comprise not only said blocked isocyanate function intended to enable, by activation in step (iii), the grafting of said molecule by interaction between a surface labile hydrogen function, but also at least one radically polymerizable group containing ethylenic unsaturation(s). A group of this kind containing ethylenic unsaturation(s) will be able, after the grafting of the molecule on the surface of the substrate, to participate in a radical polymerization activated chemically or by irradiation. According to another variant embodiment, the molecule may comprise not only said blocked isocyanate function intended to enable, by activation in step (iii), the grafting of said molecule by interaction between a surface labile hydrogen function, but also one or more other blocked isocyanate functions which are not reactive under the heating conditions employed in step (iii).

Said blocked isocyanate function or functions present on the grafted molecule at the end of step (iii) of the method of the invention, may carry a group of interest R_{f}, or may be activated (released) subsequent to the grafting of the molecule in step (iii), to be converted into groups of interest.

The molecule carrying at least one blocked isocyanate function may be soluble in the supercritical fluid employed, especially in supercritical CO₂. This is the case especially for molecules which carry groups which increase the hydrophobicity of the molecule or else groups forming few hydrogen bonds.

“Soluble” in the supercritical fluid is intended to mean that it is possible, under the conditions of implementation, to dissolve said molecule at a rate of at least 5 g of compound per 100 g of supercritical fluid. The skilled person is capable of adjusting the operating conditions so as to allow introduction of the desired amount of molecules to perform the grafting. It is possible especially, by adjusting the pressure within the reactor, to increase the concentration of molecules which can be employed.

Alternatively, the molecule carrying at least one blocked isocyanate function may have a solubility in the supercritical fluid of less than 5 g of compound per 100 g of supercritical fluid. In this case it is possible to increase the solubility of the molecule to be grafted by addition of one or more cosolvents, such as, for example, acetone, ethanol, methanol or THF.

A “blocked isocyanate function” is an isocyanate function which is inactivated by the presence of a blocking agent and which is capable of being released, i.e. activated, under the effect of heat. The isocyanate function is liberated during a chemical reaction which is activated thermally, such that at a temperature lower than a given temperature, referred to as the activation or release temperature of the blocked isocyanate function, the isocyanate function is not accessible.

A blocked isocyanate function carried by the molecule employed according to the method of the invention may correspond more particularly to the formula:

—NH—C(═O)—B_{(I)}, [Chem]

in which B represents a radical derived from a blocking agent BH selected from organic compounds containing one or more, preferably a single, labile hydrogen atom(s).

The blocking agents prevent the reaction of the isocyanate groups, at a temperature lower than the activation temperature, with labile hydrogen atoms, but allow such a reaction at a temperature above said activation temperature, after thermal release of the isocyanate function.

The activation temperature of a blocked isocyanate function is of course dependent especially on the chemical nature of the blocking agent.

Preferably the activation temperature of said blocked isocyanate function is between 75° C. and 170° C., preferably between 75° C. and 120° C. More particularly it is less than or equal to 120° C., more particularly less than 100° C., or less than or equal to 80° C., in order to prevent any thermal degradation of the substrate to be functionalized.

The isocyanate function generated after heating in step (iii) advantageously exhibits excellent reactivity, permitting rapid reaction with the labile hydrogen functions on the surface of the substrate.

The blocking agents may be of various kinds. The skilled person is capable of employing an appropriate blocking agent, more particularly with regard to the activation temperature desired for the blocked isocyanate function.

The blocking agent may for example be selected from:
alcohols, especially monoalcohols, containing preferably from 1 to 10 carbon atoms, for example butanol, ethanol or isopropanol;
phenols, especially monophenols, containing more particularly from 6 to 50 carbon atoms, preferably from 6 to 20 carbon atoms, such as ortho-cresol, para-cresol, 2,6-dimethylphenol, and 2-tert-butyl phenol;
amides and more particularly cyclic amides, containing especially from 3 to 50 carbon atoms, such as caprolactam, methylacetamide, imides such as succinimide and succinimides substituted especially by one or two C₁₋₆ alkyl radicals;
oximes, especially C₂₋₅ oximes, such as acetone oxime, methyl ethyl ketone oxime (MEKO), methyl isopropyl ketone oxime, 2-butanone oxime, methylisobutyl ketone oxime, diisobutyl ketone oxime and diisopropyl ketone oxime;
ß-dicarbonyl compounds, especially ß-diesters, ß-diketones and ß-ester ketones, such as di-C₁₋₆ alkyl malonates, for example diethyl malonate, C₁₋₆ alkyl acetoacetates, for example ethyl acetoacetate or tert-butyl acetoacetate, or else 2,4-pentanedione;
pyrazoles, more particularly 3-methylpyrazole and 3,5-dimethylpyrazole,
esters of hydroxycinnamic acid and C₁₋₆ alcohols,
triazoles such as benzotriazole,
imidazolines such as 2-phenylimidazoline, 2,4-dimethylimidazoline and 4-methylimidazoline,
tetrahydropyrimidines, and
imidazoles, such as 2-ethyl-4-methylimidazole.

Examples of blocking reactants are given for example in the Rolph et al. publication [1]. The blocking agent is preferably selected from alcohols, more particularly monoalcohols, oximes, especially methyl ethyl ketone oxime (MEKO) or 2-butanone oxime, and cyclic amides, more particularly caprolactam.

The blocked isocyanate function may therefore more particularly be a urethane or urea function. It may therefore correspond to the formula (I) above, in which B represents: a radical —OR, where R represents linear or branched C₁ to C₆, more particularly C₂ to C₄, alkyl group; or a radical —O—N═CR¹R², where R¹ and R² represent, independently of one another, a hydrogen atom or a linear or branched C₁ to C₆ alkyl group, preferably C₁ to C₄ alkyl groups; or a radical —NR′R″, where R′ and R″, together with the nitrogen atom carrying them, form a lactam cyclic group.

The lactam groups represent groups of formula:

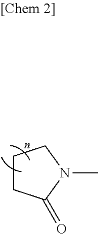

where n represents 1,2,3 or 3.

According to one particular embodiment, the molecule employed in step (ii) of the method of the invention carries a single blocked isocyanate function, for example a urethane function.

It may be obtained by reacting an appropriate blocking agent with a compound containing a free isocyanate function. Examples of such molecules are given in the remainder of the text.

According to another particular embodiment, as described in the remainder of the text, the molecule employed in step (ii) of the method of the invention may carry at least two blocked isocyanate functions, more particularly two or three blocked isocyanate functions. The molecule preferably has at least two blocked isocyanate functions, especially of urethane or urea type, which are different, more particularly having different activation temperatures.

The molecules carrying at least two blocked isocyanate functions may be obtained by reacting one or more appropriate blocking agents with a compound containing at least two isocyanate functions, more particularly comprising two or three isocyanate functions. Compounds containing at least two free isocyanate functions have already been described in the literature, for example in the publication by Delebeck et al. [2]

These may be, more particularly, diisocyanates or polyisocyanates of low molecular mass, or else synthetic oligomers or polymers of any chemical kind, obtained by polyaddition, polycondensation and/or grafting, or polymers of natural origin, optionally modified chemically, which carry two or more than two isocyanate functions, either at the chain ends or on side groups.

The compound carrying at least two free isocyanate functions is preferably selected from diisocyanate and triisocyanate compounds.

The diisocyanate and triisocyanate compounds may more particularly be selected from:
aliphatic, cycloaliphatic and/or aromatic diisocyanates. For example, possible aliphatic diisocyanate compounds include hexamethylene diisocyanate (HDI), isophorone diisocyanate (IPDI), bis(4-isocyanatocyclohexyl)methane (“hydrogenated MDI” H₁₂MDI), hydrogenated xylylene diisocyanate (H₆XDI) and m-tetramethylxylylene diisocyanate (TMXDI).

Possible aromatic diisocyanate compounds include toluene diisocyanate (TDI), diphenylmethane diisocyanate (MDI), xylylene diisocyanate (XDI) and para-phenylene diisocyanate (PPDI).
aliphatic, cycloaliphatic and/or aromatic triisocyanates, such as:
triisocyanates obtained by reaction of a triol with an excess of diisocyanate, especially those of formula

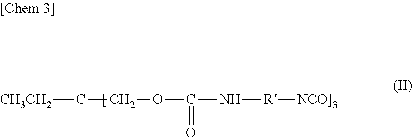

isocyanatobiurets of formula:

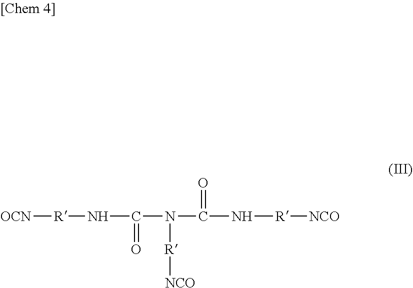

isocyanurates of formula:

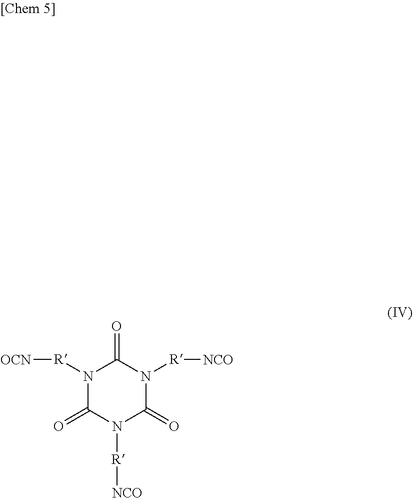

in which R′s represent, independently of one another, a linear, branched or cyclic hydrocarbon radical containing from 2 to 30 carbon atoms, more particularly an alkylene containing from 4 to 6 carbon atoms.

The molecule employed in step (ii) is preferably obtained on the basis of a compound selected from aliphatic or aromatic diisocyanates as described above, for example HDI, and the isocyanatobiurets of formula (ITT) as described above.

According to one variant embodiment, the molecule employed in step (ii) carries two blocked isocyanate functions, more particularly two urethane-type functions. It is preferably obtained from hexamethylene diisocyanate (HDI).

According to another variant embodiment, the molecule employed in step (ii) carries three blocked isocyanate functions, more particularly three urethane functions. It is preferably obtained from an isocyanatobiuret as described above, for example 1,3,5-tris(6-isocyanatohexyl)biuret.

The molecule carrying at least one blocked isocyanate function, preferably two or three blocked isocyanate functions, especially urethane functions, may be available commercially.

Alternatively, it may be obtained, prior to the implementation of the method of the invention, by reaction of a compound containing at least one isocyanate function, more particularly comprising two or three isocyanate functions, with one or more appropriate blocking agents.

The method of the invention, performed in a supercritical fluid medium, preferably in a supercritical CO₂ medium, may comprise more particularly the following steps:
placing the substrate to be functionalized in the reactor (autoclave);
charging the reactor with supercritical fluid;

For example, the reactor may be charged with liquid carbon dioxide, then carbon dioxide in the supercritical state is generated by bringing the reaction to a temperature of 32° C. and to a pressure of 70 bar.

Alternatively, in the case of an industrial reactor, CO₂ in the supercritical state may be introduced directly into the reactor.
introducing said organic molecule or molecules carrying at least one blocked isocyanate function, preferably conveyed in the supercritical fluid, more particularly in the supercritical CO₂, at a temperature strictly less than the activation temperature of said blocked isocyanate function;
increasing the temperature of the reactor, to obtain a value greater than or equal to the activation (or release) temperature for said blocked isocyanate function;

the reactor, during these steps, being maintained under pressure and temperature conditions within the supercritical range for the fluid employed, especially in the supercritical range for carbon dioxide.

It is of course within the capacities of the skilled person to adjust the quantity of molecules employed according to the invention, especially with regard to the surface of the substrate to be functionalized and to the desired degree of grafting.

The degree of grafting of said molecule on the surface of the substrate is dependent especially on the steric bulk associated with the grafted molecule, which prevents the grafting of other molecules.

Typically, from 5% to 50%, more particularly from 5% to 25%, more particularly still from 6% to 20% of the labile hydrogen functions, for example hydroxyl functions, present on the surface of the substrate may be grafted by said molecule.

The skilled person has the capacity to employ heating at a temperature sufficient to allow the activation of at least one blocked isocyanate function carried by the molecule. The heating is performed accordingly in step (iii) at a temperature greater than or equal to the activation temperature for said blocked isocyanate function.

The heating in step (iii) may be performed at a temperature of between 75° C. and 120° C., more particularly between 80° C. and 100° C.

It would be appreciated that the temperatures employed according to the method of the invention must not cause degradation to the substrate.

It is possible advantageously to lower the activation temperature of a given blocked isocyanate function by adding an appropriate catalyst.

Therefore, according to one variant embodiment, the method of the invention may comprise the addition of one or more catalysts, further to the addition of at least said molecule carrying at least one blocked isocyanate function.

These catalysts are capable more particularly of activating the reactivity of secondary amines and hydroxyl-type functions.

Such catalysts may be selected more particularly from tertiary amines such as 1,4-diazabicyclo[2.2.2]octane (DABCO), 1-azabicyclo[2.2.2]octane (quinuclidine), 1,8-diazabicyclo[5.4.0]undec-7-ene (DBU, CAS: 6674-22-2),1,5-diazabicyclo[4.3.0]non-5-ene (DBN, CAS:3001-72-7),3,3,6,9,9-pentamethyl-2,10-diazabicyclo[4.4.0] dec-1-ene, tin chloride, organometallic compounds such as metal acetonylacetates, organometallic compounds of tin, calcium hexanoate, calcium 2-ethylhexanoate, calcium octanoate and calcium linoleate, dibutyltin dilaurate (DBTDL, CAS: 75-58-7), bismuth tris(2-ethylhexanoate) and zinc bis(2-ethylhexanoate), sulfonimides, such as bis(trifluoromethane)sulfonimide (TFMI, CAS:82113-65-3), sulfonic acids, such as trifluoromethanesulfonic acid (triflic acid), p-toluenesulfonic acid (PTSA, CAS: 104-15-4) and methanesulfonic acid (MSA, CAS: 75-75-2), phosphate derivatives, such as diphenyl phosphate (DPP, CAS:838-85-7).

The catalyst is preferably selected from 1,4-diazabicyclo[2.2.2]octane (DABCO), 1,8-diazabicyclo[5.4.0]undec-7-ene (DBU), 1,5-diazabicyclo[4.3.0]non-5-ene (DBN), dibutyltin dilaurate (DBTDL), bis(trifluoromethane), triflic acid, p-toluenesulfonic acid (PTSA), methanesulfonic acid (MSA) and diphenyl phosphate (DPP).

Said catalyst or catalysts may be employed at from 0.1% to 5% by mass, preferably from 0.5% to 1% by mass, relative to the mass of said molecule or molecules carrying at least one blocked isocyanate function.

The supercritical fluid enables, advantageously, easy removal of the byproducts and unreacted products; the catalyst can be added in substantial amounts, advantageously in an amount of greater than or equal to 0.5% by mass, relative to the mass of said molecule or molecules carrying at least one blocked isocyanate function.

The blocking agent, BH, liberated in the activation of said isocyanate function in step (iii) may be removed from the reactor. It may advantageously be recycled, in order to be used, for example, as a blocking agent for the preparation of a molecule containing blocked isocyanate functions that is employed in a method according to the invention.

At the end of step (iii) of the method of the invention, the substrate is provided on its surface with said molecule, grafted covalently to the surface of the substrate, more particularly via a covalent bond of urethane type (—NH—C(O)O—), when the labile hydrogen functions of the substrate are hydroxyl functions.

The substrate thus surface-functionalized may be recovered at the end of step (iii), where appropriate after one or more steps of washing in the supercritical fluid, more particularly in supercritical CO₂, followed by letdown of the reactor.

Washing may be performed, for example, by circulating the supercritical fluid in the reactor.

The step of letting down the reactor consists more specifically of lowering the pressure to atmospheric pressure and of evacuating the carbon dioxide, preferably in gas form. The step is carried out advantageously at a temperature which ensures the transition from supercritical CO₂ phase to CO₂ gas, avoiding the liquid phase of CO₂. This step is therefore advantageously carried out at a temperature of between 45 and 85° C.

Alternatively, as detailed in the remainder of the text, the method of the invention may comprise one or more subsequent steps, after the grafting of said molecule on the surface of the substrate, these steps being intended to modify the other blocked isocyanate functions optionally present on the grafted molecule.

Functionalization Variants

As set out above, the molecule employed in step (ii) of the method of the invention may carry not only one or more blocked isocyanate functions but also at least one group of interest, which is to be exploited subsequently to the grafting of said molecule onto the surface of the substrate.

According to one variant embodiment, the molecule may carry one or more blocked isocyanate functions, preferably a single blocked isocyanate function, and at least one radically polymerizable group containing ethylenic unsaturation(s), preferably a single radically polymerizable group containing ethylenic unsaturation(s).

The term “group containing ethylenic unsaturation(s)” refers to a radical containing at least one polymerizable ethylenic unsaturated function.

The group containing ethylenic unsaturation(s) may be selected, for example, from acrylate, methacrylate, allyl and vinyl groups, preferably from (meth)acrylate groups. Molecules of this kind carrying a blocked isocyanate function and a group containing ethylenic unsaturation(s) may be obtained by reacting a compound which carries an isocyanate function and a group containing ethylenic unsaturation(s), preferably a (meth)acrylate function, with an appropriate blocking agent, of oxime type, for example. Possible examples include urethanes obtained from the reaction of an oxime, for example 2-butanone oxime, with 2-isocyanatoethyl methacrylate or 3-isopropenyl-α,α-dimethylbenzyl isocyanate.

At the end of the grafting of said molecule in step (iii), the functionalized surface of the substrate therefore has groups containing ethylenic unsaturation(s), grafted covalently to the surface of the substrate and accessible for a radical polymerization.

Accordingly, in the context of this variant embodiment, the method may comprise a radical polymerization step subsequent to the grafting of said molecule onto the surface of the substrate, this step being activated chemically or by irradiation, on the basis of radically polymerizable monomers, more particularly monomers containing ethylenic unsaturation(s), for example di(meth)acrylate monomers.

The radical polymerization may advantageously be performed in a supercritical CO₂ medium, more particularly within the reactor which has been used for functionalizing the substrate, without removal of the functionalized substrate from the reactor.

The radical polymerization may be activated in the presence of a free radical initiator, of azo or peroxo type, for example, such as azobisisobutyronitrile (AIBN).

According to another variant embodiment, the molecule employed according to the invention may carry at least two blocked isocyanate functions, preferably two or three blocked isocyanate functions, said molecule being derived more particularly from a diisocyanate or triisocyanate compound as described above.

Said molecule may advantageously carry at least two different blocked isocyanate functions, preferably of urethane and/or urea type. The molecule employed according to the invention may more particularly carry not only a first blocked isocyanate function, of urethane or urea type, for example, which can be activated by heating in step (iii), but also one or more blocked isocyanate functions, of urethane or urea type, for example, which is or are separate from said first blocked isocyanate function and is or are non-activatable under the heating conditions employed in step (iii).

In other words, the molecule employed in step (ii) of the method of the invention may carry:
a first blocked isocyanate function, preferably a urea or urethane function, denoted F1, having a given activation temperature T1; and
at least one, more particularly one or two, blocked isocyanate function(s), which is or are different from said first blocked isocyanate function, preferably of urethane or urea type, denoted F2, which is or are non-activatable under the heating conditions employed in step (iii) for releasing said function F1, more particularly non-activatable at a temperature T1. Said blocked isocyanate function or functions F2 may or may not be thermolabile. Where said blocked isocyanate function or functions F2 after thermolabile, they can be activated by heating at a temperature greater than or equal to an activation temperature T2, T2 being strictly greater than T1.

The difference in reactivity, in other words the activation temperatures, of the blocked isocyanate functions may be controlled via the use of blocking agents of different kinds.

Accordingly, a molecule containing at least two different blocked isocyanate functions, F1 and F2, may be obtained by reacting a compound containing at least two isocyanate functions, preferably two or three isocyanate functions, more particularly a diisocyanate or triisocyanate compound as described above, with at least two different blocking agents BH as defined above.

The heating in step (iii) is advantageously performed at a temperature greater than or equal to T1 and, where the function or functions F2 are thermolabile, strictly less than T2, in order to bring about the release of said blocked isocyanate function F1 and the covalent grafting of said molecule by reaction of said isocyanate function with a labile hydrogen function on the surface of the substrate.

Advantageously, the substrate at the end of step (iii) may therefore be surface-functionalized by one or more blocked isocyanate functions, of urethane type, for example, which are bonded covalently to the substrate, via the covalent bond, for example of urethane type, which is formed at the end of the reaction of an isocyanate function, obtained from the blocked isocyanate function F1, with a labile hydrogen function carried by the substrate, without release of said blocked isocyanate function or functions F2.

The blocked isocyanate function or functions present on the surface of the substrate obtained at the end of step (iii) may contain a group of interest, or may be subsequently activated and converted into groups of interest via their interaction with a compound carrying a labile hydrogen function, so as to obtain the desired functionalization on the surface of the substrate.

Advantageously, the use of a molecule containing at least two blocked isocyanate functions, preferably of urethane or urea type, F2, which are not activated at the end of the grafting in step (iii) of said molecule on the surface of the substrate makes it possible to increase the degree of grafting (degree of coverage) of the surface of the substrate, in other words the quantity of grafting with groups of interest per site available on the surface of the substrate.

According to a first variant embodiment, as illustrated in example 2, said blocked isocyanate function or functions, F2, of urethane or urea type for example, which are not activatable under the heating conditions employed in step (iii) contain at least one group of interest R_{f}. The blocked isocyanate function may, for example, be of formula —NH—C(═O)—B, where B is as defined above, B carrying at least one group of interest R_{f}.

In the context of this variant embodiment, said blocked isocyanate function or functions F2 are preferably nonthermolabile functions, in other words being unable to generate isocyanate functions by heating in the range of thermal stability of the substrate to be functionalized.

Where said blocked isocyanate function or functions F2 are thermolabile, they have an activation temperature T2 which is strictly greater than T1.

Preferably the difference between the respective activation temperatures of said blocked isocyanate functions F1 and F2, T2-T1 is at least 20° C., preferably from 30° C. to 60° C. A distance of this kind prevents any risk of activation of said blocked isocyanate function or functions F2 during the grafting of the molecule in step (iii).

At the end of step (iii), the surface of the substrate therefore advantageously has groups of interest which are grafted covalently, via the molecule, onto the surface of the substrate.

The substrate whose surface is functionalized by the groups of interest R_{f} may be recovered in a step (iv) subsequent to step (iii), where appropriate after one or more steps of washing in the supercritical fluid, as described above.

According to one variant embodiment, said molecule employed in step (ii) of the method of the invention carries not only a first blocked isocyanate function, preferably a urethane function, denoted F1, which can be activated by heating at a temperature greater than or equal to a given temperature, referred to as the activation temperature, denoted T1, but also at least one, more particularly one or two, blocked isocyanate function(s) preferably of urethane type, denoted F2, which is or are activatable by heating at a temperature greater than or equal to an activation temperature T2, T2 being strictly greater than T1. As described above, the difference between the respective activation temperatures of said blocked isocyanate functions F1 and F2, T2-T1, is preferably at least 30° C., preferably from 40° C. to 60° C. The blocked isocyanate function or functions F2, more particularly of urethane type, may be subsequently activated in order to obtain the grafting by the desired groups of interest.

In the context of this variant, the method of the invention may comprise at least the following steps:

(i) providing a substrate having labile hydrogen functions on the surface;

(ii) bringing said substrate into contact, in a supercritical fluid, more particularly in supercritical CO₂, with at least one organic molecule which carries a blocked isocyanate function F1, which can be activated by heating at a temperature greater than or equal to T1, and at least one blocked isocyanate function F2, which can be activated by heating to a temperature greater than or equal to T2, T2 being strictly greater than T1;

(iii) subjecting the whole to a temperature greater than or equal to T1 and strictly less than T2, to bring about the release of said blocked isocyanate function F1 and the covalent grafting of said molecule by reaction of said isocyanate function with a labile hydrogen function on the surface of the substrate; (iv′) subjecting the substrate obtained at the end of step (iii) to a temperature greater than or equal to T2, to bring about the release of said blocked isocyanate function or functions F2; (v′) bringing said substrate obtained at the end of step (iv′) into contact, in said fluid in the supercritical state, more particularly in supercritical CO₂, with at least one compound carrying at least one labile hydrogen function, under conditions conducive to the interaction of the labile hydrogen function carried by said compound with an isocyanate function on the surface of the substrate; and (vi′) recovering said substrate.

The whole of steps (i) to (v′) of the method may advantageously be carried out within the same reactor in a supercritical fluid, more particularly in supercritical CO₂.

A variant of this kind is illustrated for example in examples 1 and 3 below.

The compound carrying at least one labile hydrogen function may be of various kinds, provided that it has a labile hydrogen function which is capable of interacting with a free surface isocyanate function. It may be selected, for example, from primary and secondary amines, alcohols, silanols (aliphatic, aromatic, fluorinated or perfluorinated), carboxylic acids, and small oligomers carrying these functions, and a molecule of water.

The compound carrying at least one labile hydrogen function is more particularly water, which is capable of interacting with the isocyanate functions to form amine functions grafted covalently onto the surface of the substrate.

According to one particular embodiment, the compound carrying at least one labile hydrogen function may additionally carry at least one group of interest R_{f}. The reaction in step (v′) of said compound with said free isocyanate functions grafted on the surface of the substrate at the end of step (iv′) thus leads advantageously to the covalent grafting of the groups of interest R_{f} on the surface of the substrate.

The activated isocyanate functions F2 may alternatively be converted into groups of interest. By way of example, the reaction of an active isocyanate function with a molecule of water results in the formation of an amine function grafted covalently on the surface of the substrate via said grafted molecule.

A substrate of this kind, surface-functionalized by amine functions, may find advantageous applications, for example for the trapping of volatile organic compounds (VOC) of aldehyde type, for example formaldehyde or acetaldehyde.

The skilled person has the capacity to adjust the operating conditions for the implementation in step (v′) of the reaction of a free isocyanate function on the surface of the substrate with a labile hydrogen function. More particularly, the reaction may be performed in the presence of one or more catalysts, as for example DABCO, for the reaction of a hydroxyl function with an isocyanate function.

The reaction will now be described by means of the following examples, which are of course intended to illustrate and not to limit the invention.

### EXAMPLE

### Example 1

Functionalization with an Aliphatic Diisocvanate Compound Carrying Two Functions Having Different Activation Temperatures

### Preparation of the Compound Carrying Two Blocked Isocyanate Functions

The compound carrying two blocked isocyanate functions is obtained by reacting hexamethylene diisocyanate (HDI), which carries two free isocyanate functions, with two different blocking agents, 2-butanone oxime (representing R₁OH) and caprolactam (representing R′R″N—H).

The reaction of the isocyanate functions with the blocking agents is performed in the presence of a catalyst, such as DABCO.

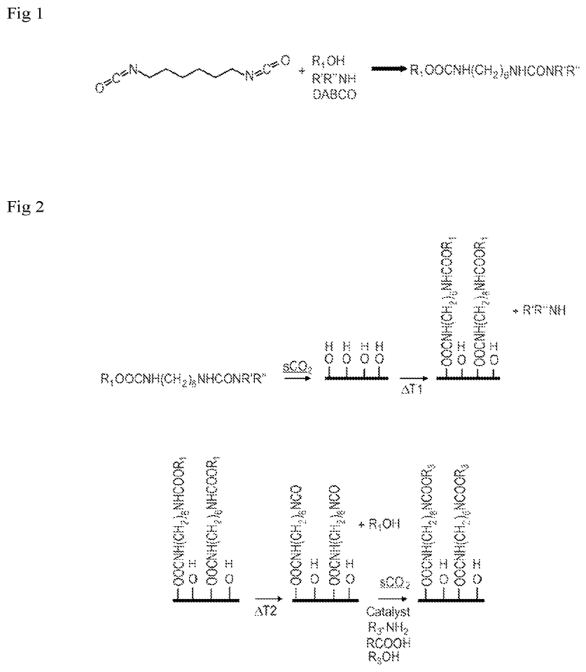

The reaction for blocking the two isocyanate functions of the HDI is represented schematically in FIG. 1.

The blocked isocyanate functions —NH—C(═O)NR′R″ and —NH—C(E)O—R₁ have activation (release) temperatures respectively of 90° C. (T1) and 120° C. (T2).

Surface Functionalization

The various steps employed for functionalizing the substrate are represented schematically in FIG. 2.

Step 1

The substrate, having labile hydrogen functions on its surface (for example, comprising cellulose fibers and/or glass fibers), is introduced into a reactor suitable for working with CO₂ in the supercritical state, with a volume of 1 liter.

The reactor is closed, charged with liquid CO₂, then heated at 80° C. in order to enter the supercritical range of the CO₂ (80° C.; 300 bar).

The reactor may alternatively be an industrial reactor charged directly with CO₂ in the supercritical state.

The compound derived from HDI and carrying two blocked isocyanate functions, prepared as described above, is introduced into the reactor.

The temperature is raised to a value of 100° C., enabling the activation of the blocked isocyanate functions —NH—C(═O)NR′R″ and the interaction of the resultant isocyanate functions with the surface hydroxyl functions.

In an industrial reactor, the unreacted molecules and the byproducts of the reaction (caprolactam) may be transported in the supercritical CO₂ and optionally recovered, for example in a separator, and recycled, to be used, for example, as a blocking agent for preparing a compound having blocked isocyanate functions.

At the end of this treatment, the substrate has blocked isocyanate functions —NH—C(O)O—R₁ on its surface, these functions having not been activated, and being grafted covalently to the surface of the substrate via urethane functions formed by reaction of the surface hydroxyls with the activated isocyanate functions obtained from the release of the —NH—C(i)NR′R″ functions.

Step 2

The temperature of the reactor is then brought to a value of 120° C., to allow the activation of the blocked isocyanate functions —NH—C(E)O—R₁.

Step 3

The activated isocyanate functions can be used for the grafting of the group R₃, where R₃ represents a group of interest (for example a high-added-value molecule), by the introduction into the reactor, in supercritical CO₂, of a mixture of R₃—OH, R₃—NH₂ and R₃—COOH and of catalyst (DABCO), as represented in FIG. 2.

### Example 2

Functionalization with an Aliphatic Triurethane Compound Carrying a Single Labile Urethane Function

Preparation of the Triurethane Compound Carrying a Single Labile Urethane Function

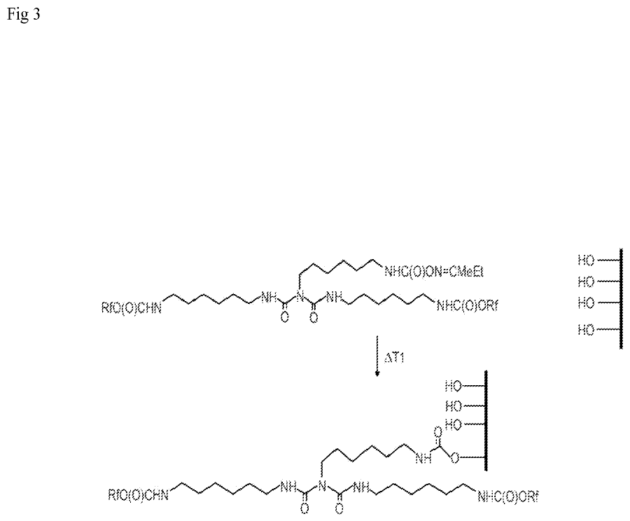

The compound carrying three blocked isocyanate functions (urethane function) is obtained by reacting 1,3,5-tris-(6-isocyanatohexyl)biuret, R_{f}—OH (R_{f} being the functional group of interest) with MEKO (methyl ethyl ketone oxime, C₂H₅C(NOH)CH₃) in proportions adjusted to obtain a compound carrying two non-labile urethane functions —NHC(O)OR_{f} and one labile urethane function —NHC(O)O—N—(CH₃)CH₂CH₃, as represented schematically in FIG. 3.

Surface Functionalization of the Substrate

The functionalization of the substrate by the triurethane compound is performed under conditions similar to those of example 1, in a reactor charged with CO₂ in the supercritical state.

The compound carrying a single labile urethane function is introduced into the reactor. The temperature is raised to a value T1 of 100° C., enabling the activation of the blocked isocyanate function —NHC(O)O—N═C(CH₃)CH₂CH₃ and the interaction of the isocyanate function thus liberated with the surface hydroxyl functions, to form a covalent urethane bond, as represented schematically in FIG. 3.

At the end of the grafting, each of the sites on the surface of the substrate (labile hydrogen) having reacted with said triurethane compound carries two functional groups of interest R_{f}. The use of a compound carrying at least three, or even more, blocked isocyanate functions, only one of them being labile under the grafting conditions, makes it possible advantageously to increase the degree of grafting with groups of interest on the surface of the substrate.

### Example 3

Functionalization of a Trifunctional Aliphatic Compound

Preparation of the Trifunctional Compound Carrying Different Labile Urea and Urethane Functions

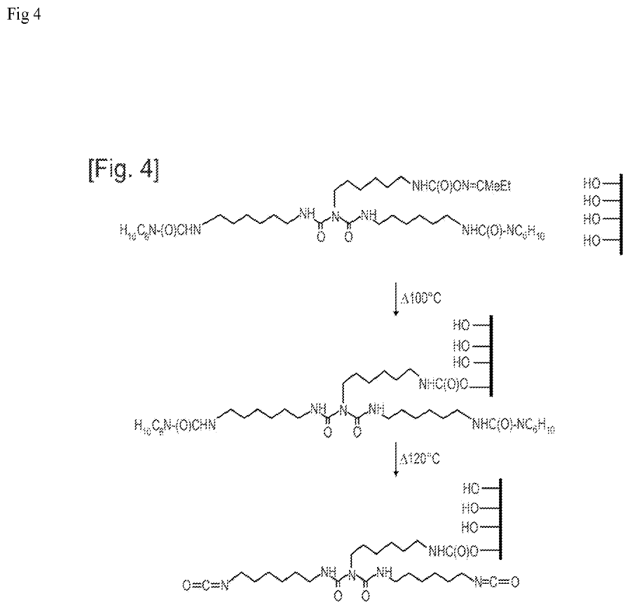

The compound carrying three blocked isocyanate functions (urea and urethane functions) is obtained by reacting 1,3,5-tris-(6-isocyanatohexyl)biuret, MEKO (methyl ethyl ketone oxime, C₂H₅C(NOH)CH₃) and caprolactam (C₆H₁₁NO) in proportions adjusted to obtain a trifunctional compound carrying one blocked isocyanate function of the type —NHC(O)O—N═C(CH₃)CH₂CH₃, and two blocked isocyanate functions of type —NHC(O)—NC₆H₁₀, as represented schematically in FIG. 4.

### Surface Functionalization of the Substrate Step 1

The functionalization of the substrate by the trifunctional compound is performed under conditions similar to those of example 1 in a reactor charged with CO₂ in the supercritical state.

The trifunctional compound is introduced into the reactor.

The temperature is raised to a value of 100° C. (T1), enabling the activation of the blocked isocyanate function —NHC(O)O—N═C(CH₃)CH₂CH₃ and the interaction of the isocyanate function thus liberated with the surface hydroxyl functions, to form a covalent urethane bond, as represented schematically in FIG. 4. The other blocked isocyanate functions (urea functions —NHC(O)—NC₆H₁₀) are not active at a temperature of 100° C.

Step 2

The temperature of the reactor is then brought to a value of 120° C. (T2), to enable the activation of the remaining isocyanate functions (release of the functions blocked with caprolactam).

These functions may where appropriate be employed for reaction with other molecules carrying at least one labile hydrogen function.

List of Documents Cited
[1] Delebeck et al., Chemical Reviews, 2013, 113, pp. 80-118.
[2] Rolph et at, Polymer Chemistry, 2016, 7, pp. 7351-7364.

1. A method for functionalizing a surface of a substrate bringing a substrate comprising labile hydrogen functions on the surface into contact, in a supercritical fluid, with at least one organic molecule comprising a blocked isocyanate function which can be activated by heating, to obtain a whole; and
subjecting the whole to a temperature sufficient to bring about a release of the blocked isocyanate function carried by the molecule, and to bring about covalent grafting of the molecule by reaction of the isocyanate function with at least one of the labile hydrogen function/on the surface of the substrate.

2. The method of claim 1, wherein the labile hydrogen functions of the substrate comprise hydroxyl, primary amine, secondary amine, and/or carboxylic acid functions.

3. The method of claim 1, wherein the substrate comprises an organic polymeric matrix comprising cellulose fibers, an organic polymeric matrix comprising polymethyl methacrylate, an organic polymeric matrix ethylene-vinyl acetate, an organic polymeric matrix partially or totally hydrolyzed polyvinyl acetate, an organic polymeric matrix polyamide, glass fiber matrix, and/or silica matrix
wherein any of the organic matrices optionally comprise glass, silica, clay, aluminum hydroxide, aluminum oxyhydroxide, and/or talc filler.

4. The method of claim 1, wherein the blocked isocyanate function has a formula
—NH—C(═O)—B,
wherein B is a radical derived from a blocking agent BH, BH being an organic compound comprising labile hydrogen atom.

5. The method of claim 4, wherein the blocking agent BH comprises an alcohol, phenol, amide, oxime, ß-dicarbonyl compound, pyrazole, ester of hydroxycinnamic acid and C1-6 alcohol, triazole, imidazoline, tetrahydropyrimidine, and/or imidazoles.

6. The method of claim 1, wherein the blocked isocyanate function is a urethane function of formula
—NH—C(═O)—B,
wherein B is —OR, being linear or branched C1 to C6, —O—N═CR¹R², R¹ and R² being independently H or a linear or branched C1 to C6 alkyl group; or NR′R″, R′ and R″, together with the nitrogen atom carrying them, formic a lactam cyclic group.

7. The method of claim 1, wherein the subjecting comprises heating to a temperature in a range of from 75 to 120° C.

8. The method of claim 1, wherein the organic molecule further comprises a radically polymerizable group comprising a ethylenic unsaturation,
wherein the method optionally further comprises, subsequent to step the subjecting, radically polymerizing, activated chemically or by irradiation, from radically polymerizable monomers.

9. The method of claim 1, wherein the organic molecule comprises at least two different blocked isocyanate functions.

10. The method of claim 9, wherein the organic compound is an aliphatic diisocyanate, aromatic diisocyanate, aliphatic triisocyanate, cycloaliphatic triisocyanates, and/or triisocyanate

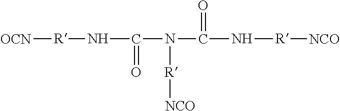

11. The method of claim 1, wherein the organic molecule in the bringing comprises:
a first blocked isocyanate function, F1, which can be activated by heating at a temperature greater than or equal to a first activation temperature, T1; and
a second blocked isocyanate function F2, which optionally can be activated at a temperature greater than or equal to a second activation temperature, T2, which is greater than T1,
wherein the subjecting comprises heating at a temperature greater than or equal to T1 and optionally less than T2, to release said the first blocked isocyanate function F1 and covalently graft the organic molecule by reacting the isocyanate function with at least one of the labile hydrogen functions.

12. The method of claim 11, wherein the second blocked isocyanate function(s) F2 comprise an Rf group, having properties of interest, and
wherein, subsequent to the subjecting, the method further comprises recovering the substrate whose surface is functionalized with the Rf groups.

13. The method of claim 11, wherein the second activation temperature T2 of the second blocked isocyanate function(s) F2, is greater than T1, and the method comprises, subsequent to the subjecting:
further subjecting the substrate obtained after the subjecting to a temperature greater than or equal to T2, to the second, blocked isocyanate function(s);
further bringing the substrate obtained after the further subjecting into contact, in the supercritical fluid, with at least one compound comprising a further labile hydrogen function, under conditions conducive to interaction of the further labile hydrogen function with an isocyanate function on the surface of the substrate; and
recovering the substrate.

14. The method of claim 13, wherein the first and second activation temperatures of the blocked isocyanate functions F1 and F2, T2-T1, differ by at least 20° C.

15. The method of claim 13, wherein the compound comprising the further labile hydrogen function is water, capable of interacting with the isocyanate functions to form amines functions grafted covalently to the surface of the substrate.

16. The method of claim 1, wherein the supercritical fluid comprises supercritical CO₂.

17. The method of claim 1, wherein the labile hydrogen functions comprise hydroxyl functions.

18. The method of claim 1, wherein the substrate is cotton, paper, wood, polyamide 6, polyamide 6-6, polyamide 11, and/or polyamide 12.
